(19) United States
(12) Patent Application Publication
(10) Pub. No.: US 2017/0216918 A1
(43) Pub. Date: Aug. 3, 2017

(54) METHODS AND SYSTEMS FOR FABRICATION USING MULTI-MATERIAL AND PRECISION ALLOY DROPLET JETTING

(71) Applicant: Melissa E. Orme-Marmarelis, Palos Verdes Estates, CA (US)

(72) Inventor: Melissa E. Orme-Marmarelis, Palos Verdes Estates, CA (US)

(21) Appl. No.: 15/422,099

(22) Filed: Feb. 1, 2017

Related U.S. Application Data
(60) Provisional application No. 62/290,424, filed on Feb. 2, 2016.
(60) Provisional application No. 62/290,415, filed on Feb. 2, 2016.

(51) Int. Cl. B22F 3/115; B22D 23/00; B33Y 10/00

(52) U.S. Cl. CPC B22F 3/115; B33Y 10/00; B22D 23/003

(57) ABSTRACT

Systems and methods directed fabrication using multi-material and precision alloy droplet jetting.

### CROSS REFERENCE TO RELATED APPLICATIONS

The present application claims the benefit of priority to U.S. Provisional Application Ser. No. 62/290,415, titled “THE PRODUCTION OF NEW ALLOYS WITH MULTI-MATERIAL DEPOSITION,” filed Feb. 2, 2016 and U.S. Provisional Application Ser. No. 62/290,424, titled “ADDITIVE MANUFACTURING MULTIPLE MATERIAL COMPONENTS WITH MULTI-MATERIAL DROPLET JETTING,” filed Feb. 2, 2016, the contents of which are incorporated herein by reference in their entirety.

### FIELD

The subject matter described herein relates generally to additive manufacturing and, more particularly, to methods and systems directed to fabrication using multi-material and precision alloy droplet jetting.

### BACKGROUND

Additive Manufacturing (AM) refers to various technologies that build 3D objects by adding layer-upon-layer of material, whether the material is plastic, metal, concrete, powder, among others. Common to AM technologies is the use of a computer, 3D modeling software (Computer Aided Design or CAD), machine equipment and layering material. Once a CAD sketch is produced, the AM equipment reads in data from the CAD file and lays downs or adds successive layers of liquid, powder, sheet material or other, in a layer-upon-layer fashion to fabricate a 3D object. Additive manufacturing processes are capable of manufacturing parts of complex shapes and geometries from a wide variety of materials.

An additive manufacturing technique is direct metal laser sintering (DMLS). In the process of sintering metal powders in DMLS, a laser beam of high intensity directly melts a metal powder, thus a part is produced without any subsequent thermal treatment.

Selective Laser Melting (SLM) is an additive manufacturing technique which is able to produce complex metallic parts from powder materials. The translation of a complex three-dimensional part into layers of two dimensions stacked on each other simplifies the job drastically and eliminates the need for die design and tooling. SLM utilizes a high powered laser to fuse small particles of powder. During the build cycle, the platform on which the build is repositioned, lowering by a single layer thickness. The process repeats until the build or model is completed. Yet another additive manufacturing technique is referred to as ARCAM, which is similar to DMLS and SLM except that the heat source is an electron beam instead of a laser.

FIG. 1 is an overview of metal powder production processes, where the metal powder is for later use in additive manufacturing. A column of molten metal issues from an orifice where it is radially impinged upon with either a gas, liquid, or plasma. The jet is ‘atomized’ into a fine spray of molten particulates of varying diameters. The particulates solidify and are collected in the chamber as shown. An alloy powder is made by mixing powders of different chemical constituents that are made via the same or a similar process. The alloy is then placed in a powder-bed Additive Manufacturing system and either fused with a laser or e-beam. The powders made in this way result in irregular shapes and diameters. Further, mixing powders to create an alloy gives only a statistical representation of its distribution. One does not know precisely how much of a first metal is in exactly one location (with micron accuracy) and how much of a second metal is in a neighboring or the same location.

Therefore, it is desirable to provide systems and methods directed to deposition of multiple materials through precision jetting which allows for uniformity and predictability in the compositions of alloys.

### SUMMARY

The various embodiments provided herein are generally directed to systems and methods for fabrication using multi-material and precision alloy droplet jetting.

The present disclosure introduces a method of alloy production with multi-material droplet deposition. Droplets with diameters on the order of 5 microns to 500 microns that are generated with capillary stream breakup have volumes on the order of picoliters to nanoliters. Droplets can be either parent and/or satellite droplets and a multitude of streams of said droplets composed of different materials are precisely deposited to the same or neighboring locations whereby they mix together and rapidly solidify. Because of the small volume of each droplet and their subsequent rapid solidification, segregation, if any, will occur on a nano or pico scale. The alloy may be made as raw stock from which it may later be machined into a useful form, or it may be deposited in-situ for Additive Manufacturing (AM) as a near-net-shape or net-shape component composed of the new alloy. The alloy can be made into a 3D form from digital information and without a mold or tooling. The alloy can further be made in bulk.

The present disclosure further introduces a method of Additive Manufacturing (AM) with multiple streams of liquid droplets, with each stream composed of a different material for the fabrication of a 2D or 3D component. One material could be the material of the final component; such as a specific metal or alloy, and the other could be a material having a lower melting point than the first material to be jetted as a support structure. Upon heating the final component the support structure can be melted away. Additionally, support structures of one material can be deposited and the structural component can be made with a plurality of different materials. For example, embodiments include the co-jetting of different materials in order to create components with added functionality such as circuitry or other sensors or cooling channels. Layered components can be fabricated where layers are composed of different materials.

According to one embodiment, molten material is deposited in the form of droplets that are approximately in the range of 5 to 500 microns in diameter. The placement position of the molten material may be guided by electrostatic charging and deflection, substrate motion, electromagnetic deflection, or other method to deflect the material mass.

Other systems, methods, features and advantages of the example embodiments will be or will become apparent to one with skill in the art upon examination of the following figures and detailed description.

### BRIEF DESCRIPTION OF FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is an overview of metal powder production processes, where the metal powder is for later use in additive manufacturing.

FIG. 2 is a cross sectional view of a droplet generation system for use with embodiments of the present disclosure.

FIG. 3 is a schematic representation of an alloy deposition process according to embodiments of the present disclosure.

FIG. 4A is a schematic representation of a multi-material deposition process according to embodiments of the present disclosure.

FIG. 4B is a schematic representation of a multi-material deposition process according to embodiments of the present disclosure.

FIG. 5 is a side view of a capillary stream and satellite droplet formation.

FIG. 6 is a schematic view of a system for generating satellite droplets for use with embodiments of the present disclosure.

FIG. 7A is a schematic view of another embodiment for generating satellite droplets for use with embodiments of the present disclosure.

FIG. 7B is a schematic view of another embodiment for generating satellite droplets for use with embodiments of the present disclosure.

FIG. 8 is a schematic view of another embodiment for generating satellite droplets for use with embodiments of the present disclosure.

FIG. 9A is a front view of an embodiment of a deflection/cooling system for use with embodiments of the present disclosure.

FIG. 9B is a side view of an embodiment of a deflection/cooling system for use with embodiments of the present disclosure.

FIG. 10A is a front view of another embodiment of a deflection/cooling system for use with embodiments of the present disclosure.

FIG. 10B is a side view of another embodiment of a deflection/cooling system for use with embodiments of the present disclosure.

FIG. 11 is a schematic view of an embodiment for direct writing of satellite droplets for use with embodiments of the present disclosure.

FIG. 12 is a schematic view of an embodiment for view writing of satellite droplets for use with embodiments of the present disclosure.

FIG. 13 is a pictorial example of an electrostatic deflection in deposition according to embodiments of the present disclosure.

FIG. 14A is a photographic demonstration of charged droplets produced by embodiments of the present disclosure.

FIG. 14B is an example of a 3D printed braid of aluminum produced by embodiments of the present disclosure.

FIG. 15A is an exemplary design for controlled droplet stream manipulation for producing powders of different characteristics according to embodiments of the present disclosure.

FIG. 15B is an exemplary design for controlled droplet stream manipulation for producing powders with two or more precisely controlled powder diameters according to embodiments of the present disclosure.

FIG. 15C is an exemplary design for controlled droplet stream manipulation for production of a monodisperse powder according to embodiments of the present disclosure.

FIG. 16 illustrates droplet stream customization examples according to embodiments of the present disclosure.

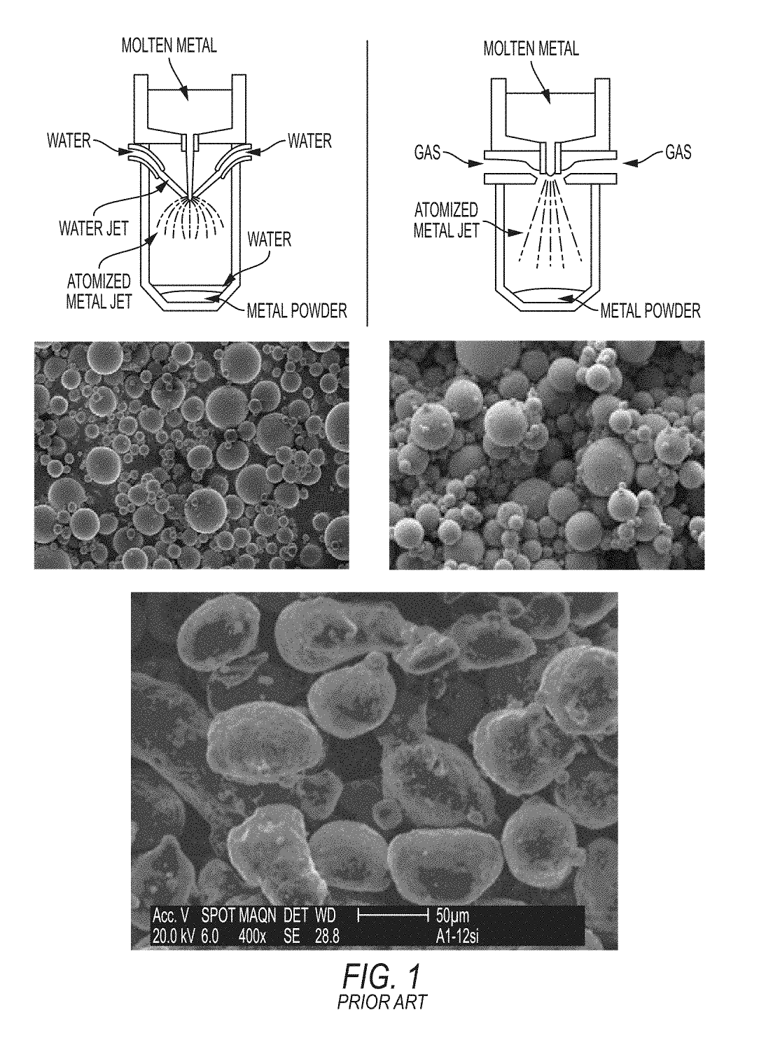

It should be noted that elements of similar structures or functions are generally represented by like reference numerals for illustrative purpose throughout the figures. It should also be noted that the figures are only intended to facilitate the description of the exemplary embodiments.

### DETAILED DESCRIPTION

Each of the additional features and teachings disclosed below can be utilized separately or in conjunction with other features and teachings to provide systems and methods directed to fabrication using multi-material and precision alloy droplet jetting. Representative examples of the embodiments described herein, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

The various embodiments provided herein are generally directed to systems and methods for fabrication using multi-material and precision alloy droplet jetting.

Embodiments of the present disclosure enable the development and 3D printing of new and existing alloys printed where the dosing of each constituent can be precisely controlled. Embodiments further enable the fabrication of net forms with multiple materials in different locations.

Further advantages provided by embodiments of the present disclosure include an unconstrained build size. The use of an inert gas shroud allows 2D and 3D printing to be accomplished outside of a build chamber. The embodiments further enable printing on large existing components for repair.

Embodiments of the present disclosure are suitable for use in a microgravity environment, i.e., can be used on a space station for 3D printing of repair parts.

Embodiments of the present disclosure can print fine features such as electronic ball grid arrays (BGA) at high speeds.

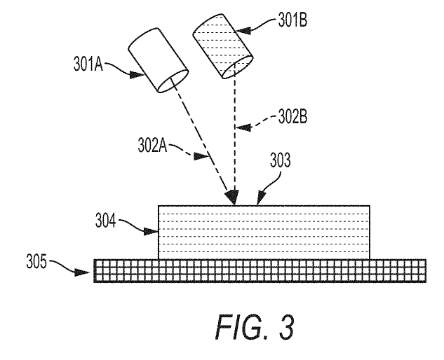

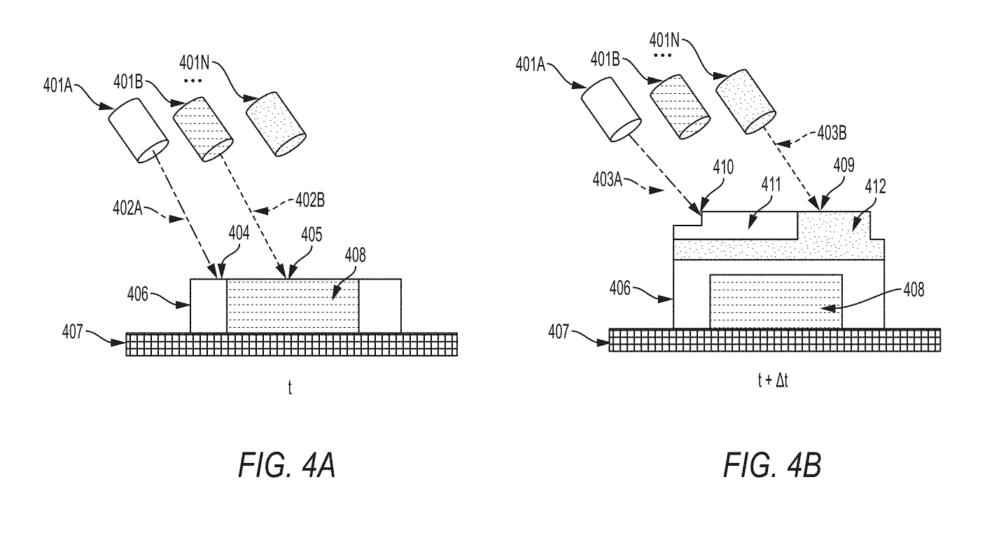

Embodiments of the present disclosure involve the deposition of a plurality of molten droplets that are generated from capillary stream breakup (parent droplets, satellite droplets, controlled-coalesced droplets or a combination thereof) and deflected with precision onto a substrate (or component that is in the process of being manufactured) where they solidify as shown in FIGS. 3, 4A, and 4B, and as described in detail below. Alternatively, the droplets do not need to be deflected, and the droplet placement can be achieved with substrate motion. Additionally, droplet placement can be achieved with a combination of substrate motion and droplet deflection. The droplets are issued into a controlled environment that may be a vacuum or an inert gas. The pressure and temperature of the controlled environment may be varied depending on the desired characteristics of the new alloy or material artifact being produced. Additionally, the substrate may be heated or cooled or maintained at a neutral temperature. The substrate may be flat or any arbitrary shape since the droplets rapidly solidify and will adhere to the shape of the substrate. The alloy may be fabricated with two materials or a plurality of materials. The ability to precisely control production characteristics of the materials and their placement allows for very precise material synthesis. For example a plurality of materials from a plurality of droplet generators do not necessarily have to have the same size droplet or be delivered at the same rate. There may be instances when one material is desired to be delivered in greater quantity than another, and yet a third at a different rate. This process allows for the complete customization of new material alloys by precisely placing the quantity of the desired materials at the desired locations.

Embodiments of the present disclosure involve the deposition of a plurality of molten droplets that are generated from capillary stream breakup (parent droplets, satellite droplets, controlled-coalesced droplets or a combination thereof) and deflected with precision onto a substrate (or component that is in the process of being manufactured) where they solidify. In one embodiment, support structures are deposited from droplets of a lower melting point material than the component material, and subsequent heating will facilitate the removal of the support structures. In another embodiment, layers of different materials can be jetted onto a substrate fabricating a composite material. In yet another embodiment, functional details can be jetted with one material and encapsulated in another material as in the case of electronics or other applications.

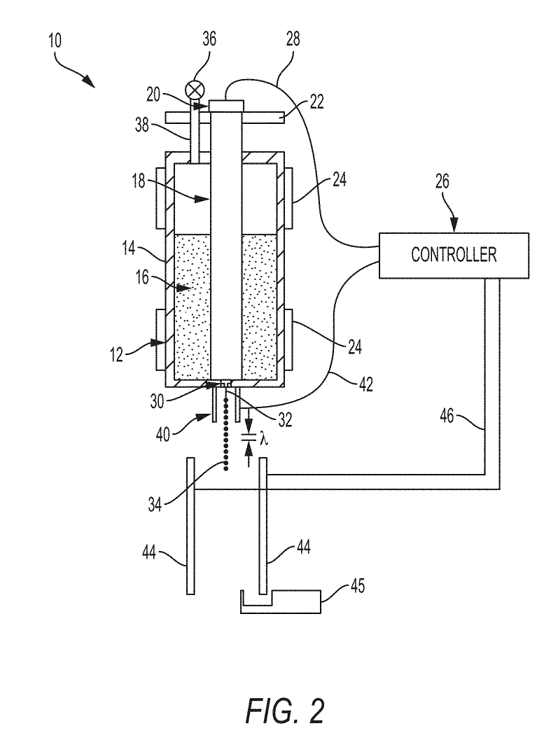

FIG. 2 is a cross sectional view of a droplet generation system 10 for use with embodiments of the present disclosure. To form a capillary stream, a droplet generator 12 is provided. The droplet generator 12 includes a chamber 14 adapted to hold a reservoir of molten metal 16 therein. This molten metal comprises any metal having physical characteristics compatible with the system 10 and method described. The melting point of some metals, for example, may be too high to use with the system 10 shown in FIG. 2. A vibrating rod 18, or other means of imparting an axisymmetric disturbance on the stream, is slidably disposed within the chamber 14, contacting the molten metal 16. For example, other means of imparting an axisymmetric disturbance may include shaking the entire apparatus by placing a piezoelectric crystal on it, or just vibrating the orifice if it is seated in a piezoelectric crystal (or lead zirconate titanate). The rod 18 is mechanically coupled to a piezoelectric crystal or transducer 20 and, as described, is used to impart a disturbance in the molten metal. However, it should be appreciated that a disturbance may be imparted mechanically with a piezoelectric transducer with or without a rod or plunger—for example, the piezoelectric transducer may be placed under the orifice to eliminate the rod or plunger—or a disturbance may be imparted from magnetic, electric or acoustic forces.

As shown, the piezoelectric crystal 20 is disposed outside the chamber 14 to protect it from the heat of the molten metal 16, as piezoelectric materials can be damaged if subjected to high temperatures. However, for metals with low melting points, such as solder, it may be possible to immerse the piezoelectric crystal in the molten fluid or position the piezoelectric crystal under the orifice where temperatures are high. To further protect the piezoelectric crystal 20 from heat transferred from the vibrating rod 18, a cooling jacket 22 may be attached to the vibrating rod 18, or to a housing around the rod 18, near the crystal 20 to keep it at a cooler temperature. The cooling jacket 22 may be, for example, fluidly coupled to a circulating water supply that circulates room temperature water through the cooling jacket 22. Additionally, to maintain the molten metal 16 inside the chamber 14 above its melting point, heaters 24 may be coupled to the outer wall of the chamber 14 at spaced-apart locations.

A controller 26, which may comprise one or more microprocessors and one or more power supplies, is electrically coupled to the piezoelectric crystal 20 by electrical connection 28. The controller 26 delivers an alternating electrical signal to the piezoelectric crystal 20, causing a corresponding mechanic response. The vibrating piezoelectric crystal 20 causes the vibrating rod 18, to which the crystal 20 is coupled, to oscillate. The vibrating rod 18 is preferably biased with a periodic or arbitrary waveform, typically with a magnitude of about 50 to 300 Volts, and a fundamental frequency f which corresponds to the frequency of perturbation applied to the capillary stream for uniform droplet production. It should be appreciated that uniform droplets may be produced at high rates and that the fundamental frequency f varies according to orifice size and stream velocity. Preferably, the fundamental frequency f, and thus the droplet production rate, is in a range of about 1000 Hz to 200 kHz.

The molten metal 16 is ejected from the chamber 14 through an orifice 30 in the bottom of the chamber 14, from which a stream 32 of the molten metal forms. The oscillation of the vibrating rod 18, or an oscillation formed by other means, produces a standing wave in the molten metal 16 and in the stream 32 as it leaves the orifice 32. Due to capillary stream break-up, molten metal droplets 34 form by detaching from the stream 32. A parent droplet 34 formed from capillary stream break-up has a diameter typically about twice the diameter of the orifice 30. With the current state-of-the-art of off-the-shelf orifices having diameters limited to 10 microns or greater, the droplets formed from streams emerging from such orifices tend to be in excess of 20 microns; however, satellite droplets are several times smaller than the parent drops. To control the formation of molten metal droplets 34 leaving the droplet generator 12, a supply 36 delivers nitrogen gas (or other inert gas, such as argon) along a gas line 38 to pressurize the chamber 14, thereby affecting the tendency of molten metal 16 to leave the chamber 14 through the orifice 30. Nitrogen (or other inert gas, such as argon) may also be supplied through a gas line to a detachable end assembly to further control solder droplets. Preferably, the inert gas is a high purity gas, such as research grade or better.

It will be appreciated that, while the schematics of droplet generation systems herein are depicted as having a single chamber and/or nozzle, droplet generation systems having multiple chambers and nozzles are used with embodiments of the present disclosure.

FIG. 3 is a schematic representation of an alloy deposition process according to embodiments of the present disclosure. Droplet generators 301A and 301B co-jet streams 302A and 302B of different materials as droplets onto an arbitrarily shaped substrate 305. Co-jetting streams 302A and 302B are directed at and droplets therefrom contact the substrate and/or layer of previously deposited material at the same point 303 to generate a layer of an alloy material 304. It will be appreciated that streams 302A and 302B may be jetted to the location simultaneously, or at different times in order to manipulate the cooling of different materials which is governed by its melting temperature and droplet size.

It will be appreciated that FIG. 3 depicts two droplet generators jetting different materials, however any plurality of droplet generators is possible in order to produce new alloys.

The embodiment depicted in FIG. 3 enables the development and 2D/3D printing of new alloys where the dosing of each constituent can be precisely controlled. The process depicted by the embodiment depicted in FIG. 3 provides a significant increase in uniformity of the deposited alloy and precise deposition of the alloy. Additionally, the process depicted by the embodiment depicted in FIG. 3 provides for the ability to produce new alloys that were not previously able to be mixed in a molten state due to material segregation issues.

FIG. 4A is a schematic representation of a multi-material deposition process according to embodiments of the present disclosure. A plurality of droplet generators 401A, 401B, . . . 401N contain different materials to jet streams of such materials at the same or different times at and droplets therefrom onto a substrate 407 or a layer of previously deposited material. Shown in FIG. 4A, droplet generator 401A co-jets a stream 402A with droplet generator 401B that is jetting stream 402B. Stream 402A is directed at and droplets therefrom contact a different position 404 than the position 405 that stream 402B is directed at and droplets therefrom contact. The material jetted from droplet generator 401B is generating a support structure 408 and the material jetted from droplet generator 401A is generating a structural component 406. These materials may be heated and assume any shape and orientation.

FIG. 4B is a schematic representation of a multi-material deposition process according to embodiments of the present disclosure. At a later time t+Δt (in relation to the schematic depicted in FIG. 4A), the structural component 406 has been built over the support structure 408 and a layer of a new material 412 has been deposited by a stream 403B from another droplet generator 401N onto the component 406. The stream 403B from droplet generator 401N is directed at and droplets therefrom makes contact with the component 406 or layer of previously deposited material at a point 409. The support structure material from droplet generator 401B has been turned off until needed in other parts of the building process. Droplet generator 401A then jets a stream 403A of material that differs from the material in droplet generator 401N at and droplets therefrom onto the new layer of material 412 or onto a layer of previously deposited material to generate another component layer 411. Stream 403A is directed at and droplets therefrom makes contact with the new layer of material 412 or a layer of previously deposited layer at a point 410. It will be appreciated that this is one illustrative example of depositing multiple materials for the fabrication of a multi-material component. A multitude of examples and configurations for multiple material jetting in a single component is possible.

The embodiments depicted in FIGS. 4A and 4B enable precision deposition for layering of multiple distinct materials, as well as deposition on all faces of existing layers or components on the substrate.

It will be appreciated that droplets in embodiments of the present disclosure are molten droplets generated from capillary stream breakup and may consist of parent droplets, satellite droplets, controlled-coalesced droplets, or a combination thereof. They may be deflected by electrostatic charging and deflection, magnetic deflection, or a combination thereof, or they may not be deflected at all and the placement on the substrate (or component that is being fabricated) may be achieved by substrate motion. Alternatively the droplet placement on the substrate may be achieved by a combination of any form of droplet deflection and substrate motion. Because nano-liter droplets solidify instantly, the substrate may be flat, or of any arbitrary shape. The substrate may be heated or cooled or maintained at a neutral temperature. The environment through which the droplets fly may be a vacuum, or an inert gas of controlled temperature and pressure.

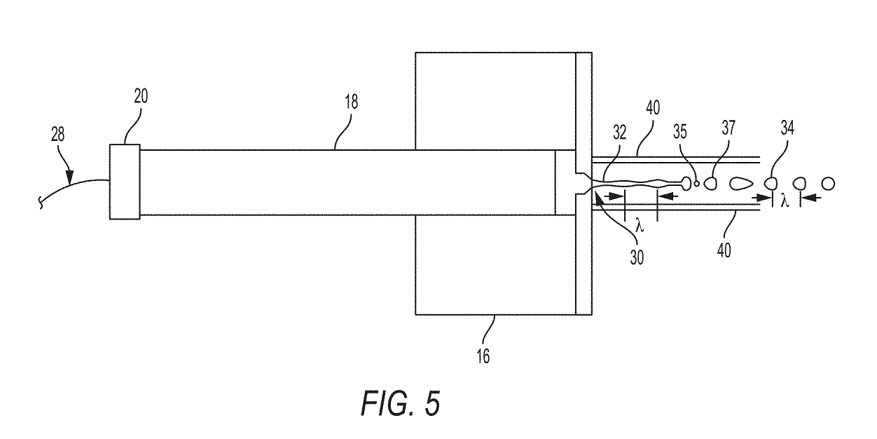

FIG. 5 is a side view of a capillary stream and satellite droplet formation. FIG. 5 illustrates the process of generating droplets from capillary stream break-up. An axisymmetric excitation disturbance is imparted to the stream 32 whose fundamental wavelength is in the region of Rayleigh growth. As described above, the disturbance is imparted by driving the piezoelectric crystal 20, to which the vibrating rod 18 is mechanically coupled, with an electrical signal representing the disturbance via line 28. Alternatively, as described above, the disturbance may be imparted with a piezoelectric transducer with or without a rod or plunger, or from magnetic, electric or acoustic forces. As illustrated, the disturbance grows, resulting in the standing wave on the stream 32 and causing the series of droplets 37,35 shown. The larger parent droplets 37 are typically on the order of twice the diameter of the orifice 30, whereas the smaller satellite droplets 35 have diameters much smaller than the orifice 30.

Depending on the characteristics of the excitation disturbance, a satellite droplet 35 will merge with the forward or rearward parent droplet 37 to form a merged droplet 34, or can be forced to maintain its position between the forward and rearward parent droplets 37 using an appropriate application of harmonics on the axisymmetric disturbance. An example of such a disturbance is one having second and third order harmonics, although many other disturbances are possible. Once the satellite droplets 35 and parent droplets 37 are formed, they are separated, and then the satellite droplets 35 or satellite and parent droplets 35,37 are cooled, to solidify, and collected.

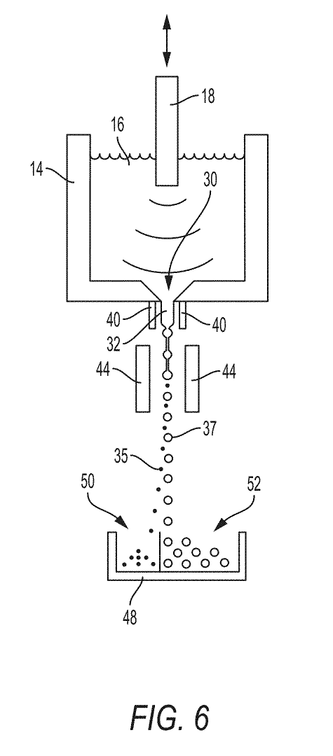

FIG. 6 is a schematic view of a system for generating satellite droplets for use with embodiments of the present disclosure. FIG. 6 illustrates one method of separating the satellite droplets from the parent droplets using electrostatic forces. A charge electrode 40 is located near the orifice 30 where droplets 37,35 break from the capillary stream 32. The charge electrode 40 allows for an electrostatic charge to be selectively applied to any of the droplets 37,35 on a droplet-by-droplet basis. The charge electrode 40 is coupled to the controller 26 by electrical connection 42. Because of the highly predictable nature of droplet formation from capillary stream break-up, the time at which droplets 37,35 break from the capillary stream 32 is known to a precise degree, given the function at which the piezoelectric crystal 20 is driven and other system parameters. It can be appreciated that an electrostatic charge on the charge electrode 40 causes a corresponding electrostatic charge on the conductive capillary stream 32. When a droplet 37,35 breaks from the stream 32, the droplet 37,35 is effectively short circuited; therefore, the droplet 37,35 will maintain that electrostatic charge while in flight. Each droplet 37,35 can thus be selectively charged, determined by the controller 26, by charging the charge electrode 40 to a predetermined value at the time that each droplet 37,35 breaks from the stream 32. After being electrostatically charged, the droplets 37,35 of molten metal are directed to pass between a pair of deflection plates 44. The bias voltage across the deflection plates 44 is controlled by the controller 26. When a bias voltage is applied across the deflection plates 44 by electrical connections 46, it can be appreciated that an electric field is formed between the plates 44. As charged droplets 37,35 pass between the plates 44, and thus through this electric field, the droplets 37,35 are acted upon by an electrostatic force. The electrostatic force on a droplet is proportional to the electric field and to the charge of the droplet.

For the embodiment shown in FIG. 6, the satellite droplets 35 will have higher charge to mass ratios than the parent droplets 37, so the electrostatic deflection of the satellite droplets 35 will be greater. Accordingly, a collector 48 is provided to catch at least the satellite droplets 35, preferably after they have solidified to avoid defects. In one aspect an embodiment, the collector has a first section 50 and a second section 52, wherein the first and second sections 50,52 are aligned to catch the satellite and parent droplets 35,37, respectively.

The magnitude of the electrostatic force acting on the droplet 37,35 determines the degree to which the droplet 37,35 is deflected—from an axis defined by the capillary stream 32—and thus the path the droplet 37,35 travels.

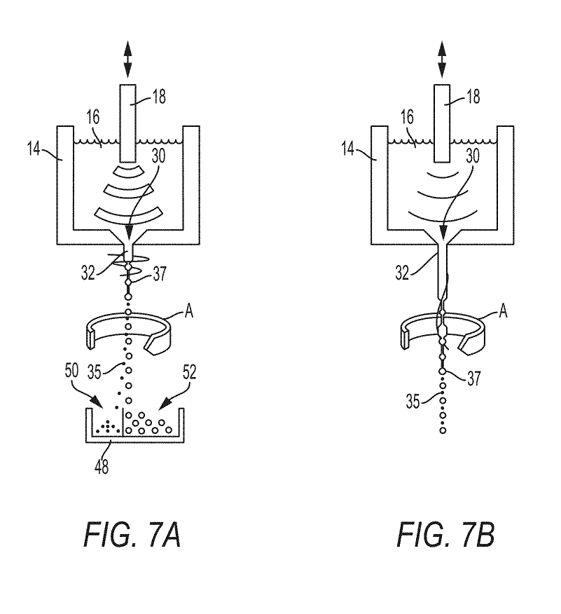

FIG. 7A is a schematic view of another embodiment for generating satellite droplets for use with embodiments of the present disclosure. FIG. 7B is a schematic view of another embodiment for generating satellite droplets for use with embodiments of the present disclosure.

Another method of separating the satellite droplets from the parent droplets is by acoustic forcing. As shown in FIGS. 7A and 7B, acoustic forcing is used to exploit the rotation imparted onto the capillary stream 32 as it exists from the orifice 30. The direction of rotation is shown by arrow A. Due to conservation of angular momentum, increasing the amplitude of the excitation disturbance (as shown in FIG. 7A) causes the satellite droplets 35 to be deflected out of the main stream and away from the parent droplets 37. When the excitation amplitude is reduced (as shown in FIG. 7B), the effects of the rotation are less pronounced, and the satellite droplets do not separate from the main stream. As with the embodiment shown in FIG. 6, a collector 48 is provided to catch at least the satellite droplets 35, preferably after they have solidified to avoid defects. The collector preferably has a first section 50 and a second section 52, wherein the first and second sections 50,52 are aligned to catch the satellite and parent droplets 35,34, respectively.

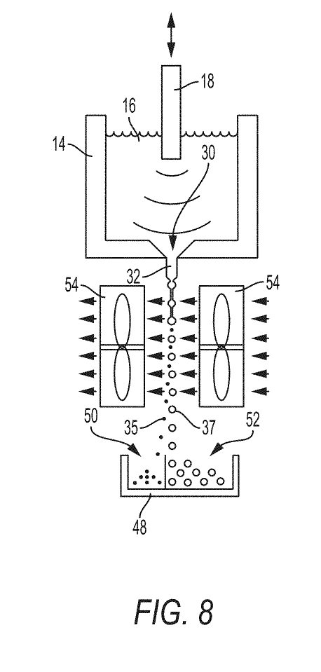

FIG. 8 is a schematic view of another embodiment for generating satellite droplets for use with embodiments of the present disclosure. Another method of separating the satellite droplets from the parent droplets uses aerodynamic forces, as shown in FIG. 8. A transverse aerodynamic force is applied to the satellite droplets 35 and parent droplets 37 by, e.g., fans 54, air jets or the like. Because of the mass difference between the satellite and parent droplets, the transverse aerodynamic force is large enough to propel the satellite droplets 35 out of the main stream, but it is insufficient to significantly affect the larger parent droplets 37. A collector 48 is provided to catch at least the satellite droplets 35, preferably after they have solidified to avoid defects.

With respect to any of the embodiments described, the parent droplets can be recycled back into the chamber 14 after they are collected. To avoid impurities, the recycled metal is preferably filtered.

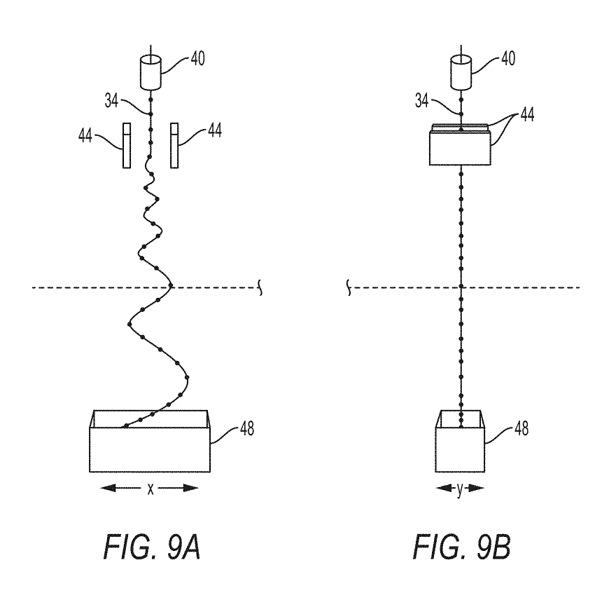

FIG. 9A is a front view of an embodiment of a deflection/cooling system for use with embodiments of the present disclosure. FIG. 9B is a side view of an embodiment of a deflection/cooling system for use with embodiments of the present disclosure. FIGS. 9A and 9B illustrate one embodiment of a method of deflecting the droplets so that each travels in a path different from its adjacent downstream droplet. As described above, each droplet 34 is selectively charged by the charge electrode 40. In this example, the droplets 34 are charged with a waveform varying in amplitude. The waveform by which the charge electrode 40—and thereby the droplets 34—are charged is produced by, e.g., a waveform generator in the controller 26, and it should be understood that any waveform that varies the charge on the droplets 34 could be used (e.g., sawtooth, sinusoid, aribitrary, non-periodic, or the like). The droplets 34 are directed between the pair of deflection plates 44, where the droplets 34 are acted upon by an electrostatic force. Each droplet 34 deflects a distance that corresponds to its charge, as described above. As FIGS. 9A and 9B show, the droplets are collected by a collector 48, preferably after they have solidified.

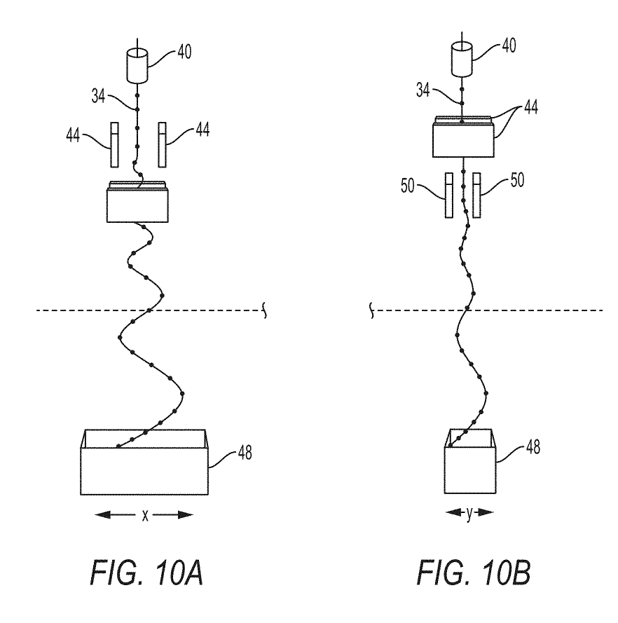

FIG. 10A is a front view of another embodiment of a deflection/cooling system for use with embodiments of the present disclosure. FIG. 10B is a side view of another embodiment of a deflection/cooling system for use with embodiments of the present disclosure.

Electrostatic deflection on two orthogonal axes can be used to separate the balls, to more effectively cool the droplets. As shown in FIGS. 10A and 10B, the selectively charged droplets 34 are directed to pass through two pairs of deflection plates 44,50, which are preferably orthogonal to each other. The embodiment shown in FIGS. 10A and 10B operates as the embodiment of FIGS. 9A and 9B, except that the droplets 34 are deflected along two axes. Further, the actual deflection of the droplets 34 in each direction can be tuned by, inter alia, adjusting the bias voltage across each pair of deflection plates 44,50.

As described above, a constant electric field (supplied by deflection plates) acts upon differently charged droplets. Alternatively, in connection with the embodiments shown in FIGS. 9A, 9B, 10A, and 10B, the droplets 34 could be deflected in similar patterns by charging each droplet 34 with the same electrostatic charge and further biasing the deflection plates 44,50 with an amplitude varying waveform. In this way, a varying electrostatic field would act upon uniformly charged droplets, instead of a constant field acting upon differently charged droplets.

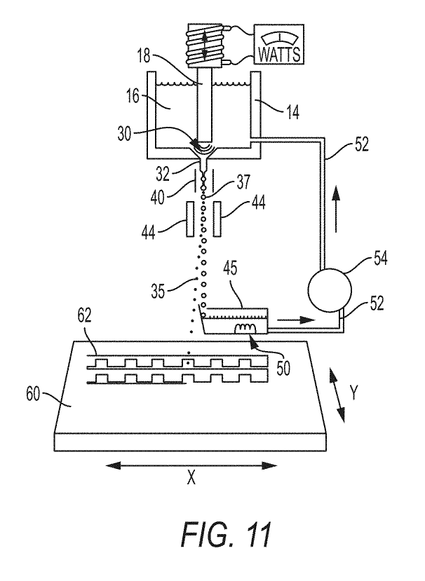

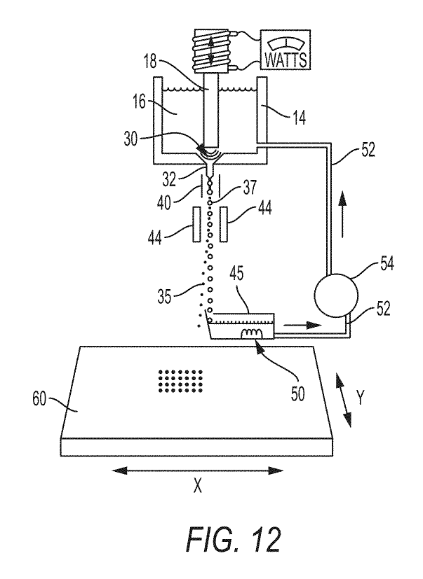

FIGS. 11 and 12 are schematic views of embodiments for direct writing of satellite droplets for use with embodiments of the present disclosure. For the embodiments shown in FIGS. 11 and 12, the satellite droplets 35 will preferably have higher charge to mass ratios than the parent droplets 37, so the electrostatic deflection of the satellite droplets 35 will be greater. Accordingly, by deflecting the satellite droplets 35 greater than the parent droplets 37, the satellite droplets 35 can be selectively directed to locations on a substrate 60 while the parent droplets 37 are caught by a gutter 45. A heater 50 may be integrated into the gutter 45 to heat the metal caught by the gutter 45 so that the metal remains in liquid form. The collected metal in the gutter 45 can be advantageously recycled back into the chamber 14 through lines 52 by pump 54. To minimize impurities, the metal is preferably filtered. The parent droplets 37 can thus be recycled back into the chamber 14 after they are collected.

As explained, the satellite droplets may be directed to predetermined locations on the substrate 60. Preferably, the substrate 60 is translatable in the direction of two orthogonal axes X and Y (e.g., by being attached to an x-y table), each of which is in a plane that is substantially orthogonal to the capillary stream 32. After being deflected by the deflection plates 44, the satellite droplets 35 impinge upon a predetermined location on the substrate 60. As described, this location is determined by setting the bias voltage of the deflection plates 44 (which, preferably, is constant), the charge on each droplet 35, and the x-y position of the substrate 60. If there are no locations suitable for locating a satellite droplet 35 on the substrate 60 at a given time, the droplet 35 is not electrostatically charged by the charge electrode 40 and falls instead into the gutter 45 to be recycled. The satellite droplets 35 may be placed at individual locations on the substrate 60, e.g., for forming a ball grid array, or they may be overlapped to form a conductive trace 62. In the latter case, thermal conditions are controlled carefully so that the newly arriving satellite droplets 35 will fuse with the trace 62 formed by previously deposited droplets 35. Because the satellite droplets may have very small diameters (e.g., on the order of 10 microns), conductive traces 62 having correspondingly small widths may be formed on the substrate 60 using this method.

Alternatively, the satellite droplets could be separated from the main stream of parent droplets by other means (e.g., using aerodynamic forces or acoustic forcing), and the resulting stationary stream of satellite droplets could be directed at a substrate that is in motion in one or two axes.

It will be appreciated that the droplet generator or plurality of droplet generators described throughout this disclosure may be positioned at arbitrary angles with respect to a fixed substrate or substrate capable of positioning up to five axes. This embodiment may be suitable for repairing large existing structures. Because of the momentum of the impinging droplets, the droplet generators do not need to be aligned with the gravity vector. For example the droplet generators may be positioned horizontally with respect to the gravity vector in order to deposit on the side face of an existing structure. The existing structure may be fixed, or it may rotate or move along one or more of its axes.

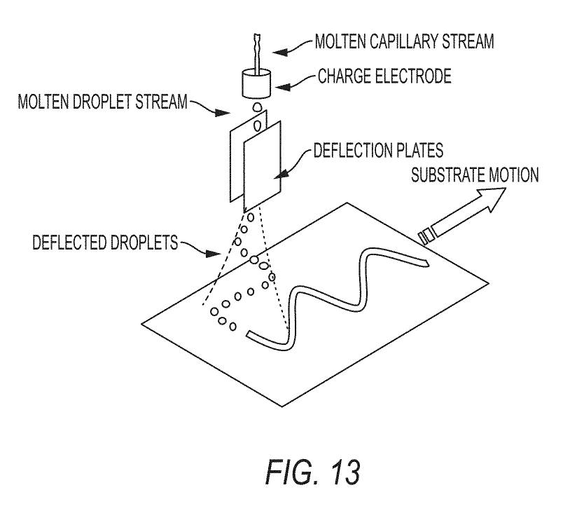

FIG. 13 is a pictorial example of an electrostatic deflection in deposition according to embodiments of the present disclosure. The process depicted in FIG. 13 illustrates precise placement of deflected droplets.

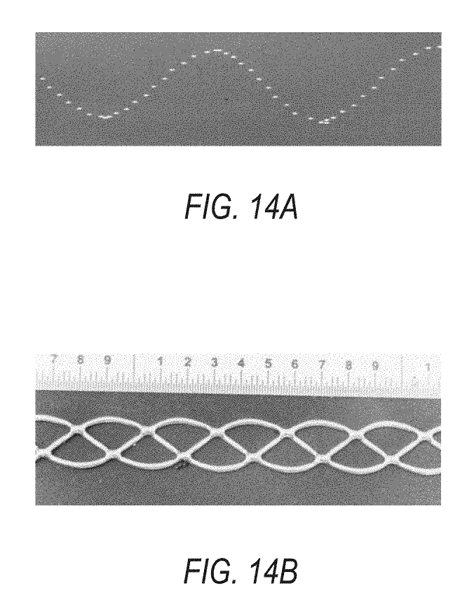

FIG. 14A is a photographic demonstration of charged droplets produced by embodiments of the present disclosure. In the process of producing the pattern shown in FIG. 14A droplets were charged according to sinusoidal pattern and the deflection field remained constant.

FIG. 14B is an example of a 3D printed continuous braid of aluminum produced by embodiments of the present disclosure.

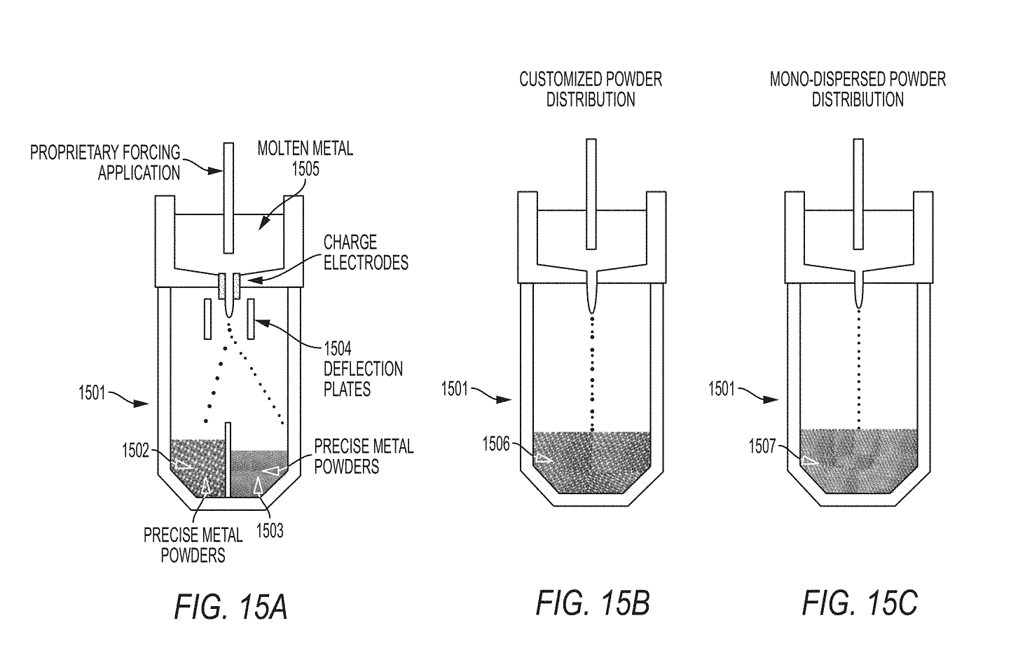

FIG. 15A is an exemplary design for controlled droplet stream manipulation for producing powders of different characteristics according to embodiments of the present disclosure. FIG. 15B is an exemplary design for controlled droplet stream manipulation for producing powders with two or more precisely controlled powder diameters according to embodiments of the present disclosure. FIG. 15C is an exemplary design for controlled droplet stream manipulation for production of a monodisperse powder according to embodiments of the present disclosure.

In FIG. 15A, multiple metal powders 1502 and 1503 can be present in chamber 1501, and deflection plates 1504 can direct the streams of molten metal 1505 to the desired container of metal powder 1502, or 1503. FIG. 15B illustrates a customized powder distribution 1506 present in chamber 1501. FIG. 15C illustrates a mono-dispersed powder distribution 1507 present in chamber 1501.

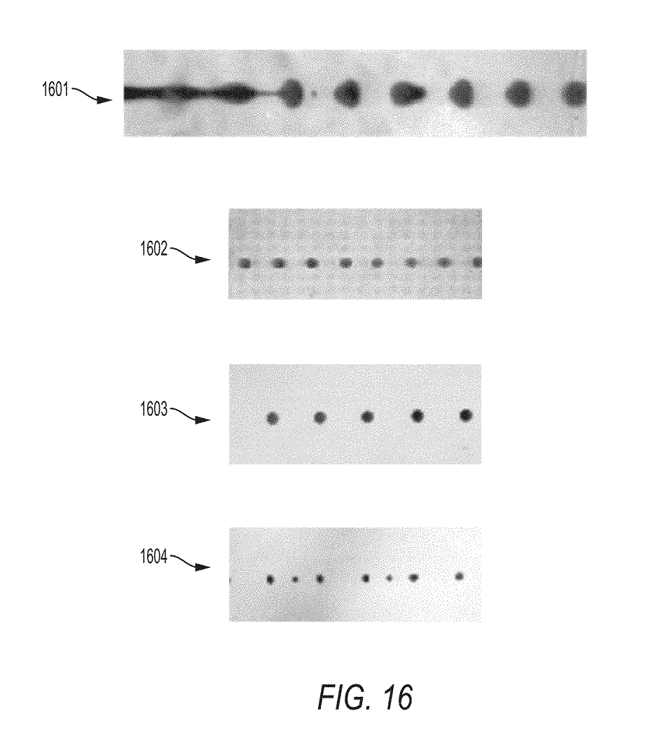

FIG. 16 illustrates droplet stream customization examples according to embodiments of the present disclosure. In FIG. 16, traditional droplet formation from a capillary stream breakup 1601 results in imprecise sphere shape and size. Droplet stream customization examples 1602, 1603, and 1604 illustrate that the configurations are stable.

Table I below illustrates examples of specifications of droplet production rates by embodiments of the present disclosure. Table I is only an example and is not intended to be a limiting, exhaustive, or all-encompassing list of specifications.

TABLE I
Aluminum Alloy ball production sizes and rates

| | | | 100 orifice array | |
|---|---|---|---|---|
| Orifice | Sphere | Production rate | production rate | Mass throughput |
| diam | diam | (spheres/ | (spheres/ | (100 orifice array) |
| (μm) | (μm) | second) | second) | (kg/hr) |
| 20 | 38 | 84,400 | 8,440,000 | 7.4 |
| 40 | 75 | 42,200 | 4,220,000 | 28.2 |
| 60 | 110 | 28,100 | 2,810,000 | 59.3 |
| 80 | 150 | 21,100 | 2,110,000 | 113.0 |
| 100 | 190 | 17,000 | 1,700,000 | 185.0 |
| 160 | 300 | 10,600 | 1,060,000 | 454.2 |

All features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. Express recitation of every possible combination and substitution is overly burdensome, especially given that the permissibility of each and every such combination and substitution will be readily recognized by those of ordinary skill in the art upon reading this description.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed:

1. A method of generating an alloy material on a substrate, comprising:
jetting a first stream of a first material from a first droplet generator of a plurality of droplet generators onto the substrate at a predetermined location of the substrate; and
jetting a second stream of a second material from a second droplet generator of the plurality of droplet generators onto the substrate at the predetermined location of the substrate;
wherein the first material is different from the second material;
wherein the first material and second material combine to generate the alloy material; and
wherein each droplet generator of the plurality of droplet generators can independently and simultaneously stream a material contained therein onto the substrate.

2. The method of claim 1, wherein the first stream of the first material contacts the predetermined location of the substrate simultaneously with the second stream of the second material.

3. The method of claim 1, wherein the second stream of the second material contacts the predetermined location of the substrate at a time that is subsequent to when the first stream of the first material contacts the position of the substrate.

4. The method of claim 3, wherein the time is based upon one or more of a first melting temperature of the first material and a second melting temperature of the second material.

5. The method of claim 3, wherein the time is based upon one or more of a first droplet size of the first material and a second droplet size of the second material.

6. The method of claim 1, further comprising:
jetting a third stream of a third material from a third droplet generator of the plurality of droplet generators onto the substrate at the predetermined location of the substrate;
wherein the third material is different from the first material and the second material; and
wherein the first material, the second material, and the third material combine to generate the alloy material.

7. The method of claim 1, wherein the first stream of first material and the second stream of the second material are comprised of molten droplets.

8. The method of claim 6, wherein the third stream of the third material is comprised of molten droplets.

9. The method of claim 7, further comprising deflecting the droplets of the first stream of the first material and the second stream of the second material to land at the predetermined location on the substrate.

10. The method of claim 1, further comprising moving the substrate to provide for the first stream and second stream landing at the predetermined location on the substrate.

11. The method of claim 9, further comprising moving the substrate to provide for the first stream and second stream landing at the predetermined location on the substrate.

12. The method of claim 8, further comprising deflecting the droplets of the third stream of the third material to land at the predetermined location on the substrate.

13. The method of claim 9, wherein the droplets are generated from capillary stream breakup and consist of one or more of parent droplets, satellite droplets, and controlled-coalesced droplets.

14. The method of claim 12, wherein the droplets are generated from capillary stream breakup and consist of one or more of parent droplets, satellite droplets, and controlled-coalesced droplets.

15. The method of claim 6, wherein the first stream of the first material contacts the predetermined location of the substrate simultaneously with the second stream of the second material and the third stream of the third material.

16. The method of claim 1, wherein the third stream of the third material contacts the predetermined location of the substrate that is subsequent to when the first stream of the first material and the second stream of the second material contact the position of the substrate.

17. The method of claim 1, wherein the alloy material is made in a 3D form from a digital information and without a mold.

18. A method of depositing multiple metals onto a substrate, comprising:
jetting a first stream of a first material from a first droplet generator of a plurality of droplet generators onto the substrate at a first predetermined location of the substrate; and
jetting a second stream of a second material from a second droplet generator of the plurality of droplet generators onto the substrate at a second predetermined location of the substrate;
wherein the first material is different from the second material; and
wherein each droplet generator of the plurality of droplet generators can independently and simultaneously stream a material contained therein onto the substrate.

19. The method of claim 18, wherein the first stream of the first material is generating a support structure and the second stream of the second material is generating a structural component.

20. The method of claim 19, wherein the first material has a first melting temperature that is lower than a second melting temperature of the second material such that the substrate can be subsequently heated to a temperature between the first melting temperature and the second melting temperature to facilitate removal of the support structure.

21. The method of claim 18, wherein the first stream contacts the first predetermined location of the substrate simultaneously with the second stream contacting the second predetermined location of the substrate.

22. The method of claim 18, further comprising:
jetting a third stream of molten droplets of a third material from a third droplet generator of the plurality of droplet generators onto a layer of the first material at a predetermined location of the layer of the first material.

23. The method of claim 18, wherein the first stream of first material and the second stream of the second material are comprised of molten droplets.

24. The method of claim 22, wherein the third stream of the third material is comprised of molten droplets.

25. The method of claim 23, further comprising deflecting the droplets of the first stream of the first material and the second stream of the second material to direct the droplets of the first stream and the second stream to land at the predetermined location on the substrate.

26. The method of claim 23, wherein the droplets are generated from capillary stream breakup and consist of one or more of parent droplets, satellite droplets, and controlled-coalesced droplets.

27. The method of claim 25, wherein the droplets are deflected by one or more of electrostatic charging and deflection, and magnetic deflection.

28. The method of claim 25, wherein the substrate can move with one or more of a droplet deflection and a stationary droplet stream.
